(19) United States
(12) Patent Application Publication
(10) Pub. No.: US 2024/0003698 A1
(43) Pub. Date: Jan. 4, 2024

(54) SYSTEM AND METHOD FOR CREATING A DRIVING ROUTE

(71) Applicant: Isaac Dorman, Springfield, VA (US)

(72) Inventor: Isaac Dorman, Springfield, VA (US)

(21) Appl. No.: 18/235,588

(22) Filed: Aug. 18, 2023

Related U.S. Application Data
(60) Provisional application No. 63/357,906, filed on Jul. 1, 2022.

(51) Int. Cl. G01C 21/36

(52) U.S. Cl. CPC G01C 21/3617; G01C 21/3664

(57) ABSTRACT

A device and method for determining a driving route. The device includes a user interface and computing hardware configured to accept the desired duration of the drive as an input for calculating the route, as well as the origin point, destination, and desired way points. The desired duration may be selected as an alternative to optimizing for the least time spent or the least fuel consumed.

### CROSS-REFERENCE TO RELATED APPLICATIONS

This application claims benefit from and priority to provisional application No. 63/357,906 filed on Jul. 1, 2022.

### DETAILED DESCRIPTION

In the following description, like reference numbers are used to identify like elements. Furthermore, the drawings are intended to illustrate major features of exemplary embodiments in a diagrammatic manner. The drawings are not intended to depict every feature of every implementation nor relative dimensions of the depicted elements, and are not drawn to scale.

In the following description, numerous specific details are set forth to clearly describe various specific embodiments disclosed herein. One skilled in the art, however, will understand that the presently claimed invention may be practiced without all of the specific details discussed below. In other instances, well known features have not been described so as not to obscure the invention.

As described herein, the term “pivotally connected” shall be used to describe a situation wherein two or more identified objects are joined together in a manner that allows one or both of the objects to pivot, and/or rotate about or in relation to the other object in either a horizontal or vertical manner.

As described herein, the term “removably coupled” and derivatives thereof shall be used to describe a situation wherein two or more objects are joined together in a non-permanent manner so as to allow the same objects to be repeatedly joined and separated.

Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

Navigation systems known in the art create driving routes based on a destination address. Users typically input a destination address in their navigation system and the navigation system creates the quickest route to that destination from the current location or a selected origin point.

According to some embodiments, a navigation system is presently disclosed that is configured to create driving routes without a destination address. According to some embodiments, the presently disclosed navigation system aids users in simply enjoying driving their cars for leisure and also finding fun routes to drive.

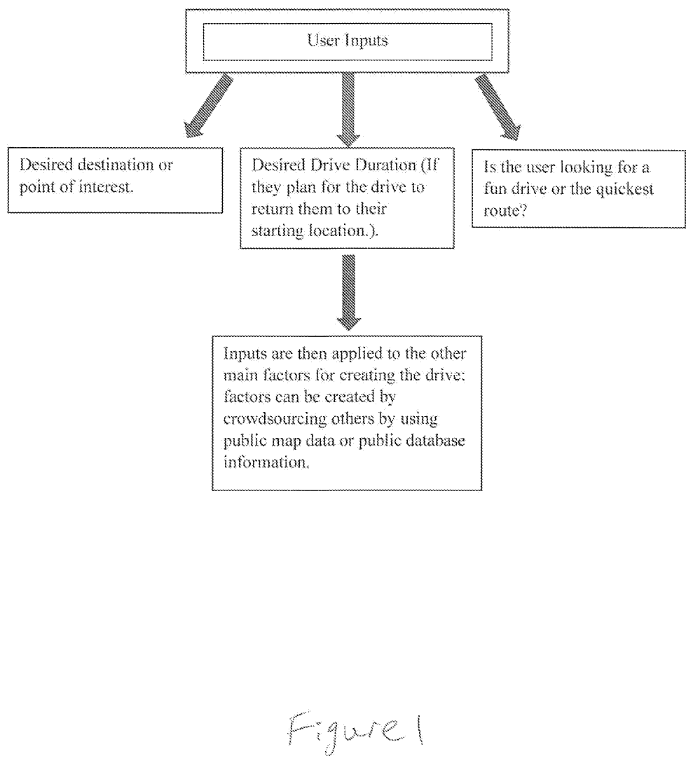

Referring to FIG. 1, a novel process is shown according to some embodiments presently disclosed.

According to some embodiments, the presently disclosed navigation system allows a user (i.e. driver) to input the starting location (for example their home address) and input length of time the drive should take. The presently disclosed navigation system may then use a number of factors to create the most fun driving route. This saves the driver the time of having to plan their own route and can help find new routes to try so that the driver does not get bored of driving the same route over and over. Although a driver may also be able to use the presently disclosed navigation system to find the quickest route to a specific destination, the presently disclosed navigation system may provide a detour option to take on a short fun drive on the way to user's specific destination.

According to some embodiments, as shown, the presently disclosed navigation system may use one or more of the following factors for creating the drive: Desired Destination: Either to a new location or to return you back to your original location or to add a point of interest the user wants to see along the route; Desired drive duration (if the drive is just for fun and is intended to return them to their original location); Is the driver looking for a fun and interesting drive or the quickest route to their destination?; Crowdsourced police reporting; Speed limits (Higher speed limits make for better drives and avoiding low speeds to prevent disturbing neighborhoods.); Bending roads (more curves are better) because just driving straight is not as fun; Using crowdsourced traffic patterns to avoid traffic, and/or; Roads with less traffic lights are also a positive factor. At least some of these factors may make the driving experience more fun for the user and to do it in a way that is safe for the driver and for the community by avoiding unnecessary traffic in neighborhoods.

According to some embodiments, the presently disclosed navigation system may allow the user to save routes for future drives. There are also various areas in the country that are already known for being great driving spots. The presently disclosed navigation system app may catalog them so that users can always find a popular route to take where ever they are.

According to some embodiments, the presently disclosed navigation system may allow the user to create a drive and then share the driving route with someone else or multiple people, so that other users can use the same route. This will allow multiple users in different vehicles to follow the same route even if they get separated. If drivers get separated, the presently disclosed navigation system may show the user where the other drivers are on the route. This feature can help groups of drivers stay together while enjoying their drives.

According to some embodiments, the presently disclosed navigation system may be implemented using a computing device such as, for example, computer, mobile phone, cellular phone, tablet, and/or laptop. The presently disclosed navigation system may be implemented using programmer-created code alone, machine learning, or artificial intelligence (AI), etc.

The computing device may comprise more or fewer components than described below, may combine two or more components, or a may have a different configuration or arrangement of the components. The various components described below may be implemented in hardware, software or a combination of both hardware and software, including one or more signal processing and/or application specific integrated circuits.

According to some embodiments, the computing device comprises memory (which may comprise one or more computer readable storage mediums), one or more processing units (CPU or chip), audio circuitry, and a speaker. These components may communicate over one or more communication buses or signal lines, and may also communicate wirelessly.

The memory may comprise high-speed random access memory and/or non-volatile memory, such as one or more magnetic disk storage devices, flash memory devices, or other non-volatile solid-state memory devices. Access to memory by other components of the computing device, such as the CPU, may be controlled by a memory controller.

The audio circuitry and the speaker provide an audio interface between a user and the computing device. The audio circuitry receives audio data, converts the audio data to an electrical signal, and transmits the electrical signal to the speaker. The speaker converts the electrical signal to human-audible sound waves to provide driving instruction.

The computing device may further comprise radio frequency (RF) circuitry and/or a touch-sensitive display. These components may also communicate over one or more communication buses or signal lines.

The radio frequency (RF) circuitry may be configured to receive and transmit RF signals, also called radio frequency signals or electromagnetic signals. The RF circuitry converts electrical signals to/from electromagnetic signals and communicates with communications networks and other communications devices via the electromagnetic signals. The RF circuitry may include well-known circuitry for performing these functions, including but not limited to an antenna system, an RF transceiver, one or more amplifiers, a tuner, one or more oscillators, a digital signal processor, a CODEC chipset, a subscriber identity module (SIM) card, memory, and so forth. The RF circuitry may communicate with networks, such as the Internet, also referred to as the World Wide Web (WWW), an intranet and/or a wireless network, such as a cellular telephone network, a wireless local area network (LAN) and/or a metropolitan area network (MAN), and other devices by wireless communication. The wireless communication may use any of a plurality of communications standards, protocols and technologies, including but not limited to Global System for Mobile Communications (GSM), Enhanced Data GSM Environment (EDGE), high-speed downlink packet access (HSDPA), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email (e.g., Internet message access protocol (IMAP) and/or post office protocol (POP)), instant messaging (e.g., extensible messaging and presence protocol (XMPP), Session Initiation Protocol for Instant Messaging and Presence Leveraging Extensions (SIMPLE), and/or Instant Messaging and Presence Service (IMPS), and/or Short Message Service (SMS)), or any other suitable communication protocol, including communication protocols not yet developed as of the filing date of this document.

The touch-sensitive display is sometimes called a “touch screen” for convenience, and may also be known as or called a touch-sensitive display system. In one embodiment, the touch-sensitive touch screen provides an input interface and an output interface between the computing device and a user. The touch screen is configured to implement virtual or soft buttons and one or more soft keyboards. The touch screen displays visual output to the user. The visual output may include graphics, text, icons, video, and any combination thereof (collectively termed “graphics”).

The touch screen may use LCD (liquid crystal display) technology, or LPD (light emitting polymer display) technology, although other display technologies may be used in other embodiments. The touch screen may detect contact and any movement or breaking thereof using any of a plurality of touch sensing technologies now known or later developed, including but not limited to capacitive, resistive, infrared, and surface acoustic wave technologies, as well as other proximity sensor arrays or other elements for determining one or more points of contact with a touch screen.

A touch-sensitive display in some embodiments of the touch screen may be analogous to the multi-touch sensitive tablets described in the following U.S. Pat. No. 6,323,846 (Westerman et al.), U.S. Pat. No. 6,570,557 (Westerman et al.), and/or U.S. Pat. No. 6,677,932 (Westerman), and/or U.S. Patent Publication 2002/0015024A1, each of which is hereby incorporated by reference in its entirety.

A touch-sensitive display in some embodiments of the touch screen may be as described in the following applications: (1) U.S. patent application Ser. No. 11/381,313, “Multipoint Touch Surface Controller,” filed May 2, 2006; (2) U.S. patent application Ser. No. 10/840,862, “Multipoint Touchscreen,” filed May 6, 2004; (3) U.S. patent application Ser. No. 10/903,964, “Gestures For Touch Sensitive Input Devices,” filed Jul. 30, 2004; (4) U.S. patent application Ser. No. 11/048,264, “Gestures For Touch Sensitive Input Devices,” filed Jan. 31, 2005; (5) U.S. patent application Ser. No. 11/038,590, “Mode-Based Graphical User Interfaces For Touch Sensitive Input Devices,” filed Jan. 18, 2005; (6) U.S. patent application Ser. No. 11/228,758, “Virtual Input Device Placement On A Touch Screen User Interface,” filed Sep. 16, 2005; (7) U.S. patent application Ser. No. 11/228,700, “Operation Of A Computer With A Touch Screen Interface,” filed Sep. 16, 2005; (8) U.S. patent application Ser. No. 11/228,737, “Activating Virtual Keys Of A Touch-Screen Virtual Keyboard,” filed Sep. 16, 2005; and (9) U.S. patent application Ser. No. 11/367,749, “Multi-Functional Hand-Held Device,” filed Mar. 3, 2006. All of these applications are incorporated by reference herein in their entirety.

In addition to the touch screen, the computing device may comprise a touchpad for activating or deactivating particular functions. The touchpad is a touch-sensitive area of the device that, unlike the touch screen, does not display visual output. The touchpad may be a touch-sensitive surface that is separate from the touch screen or an extension of the touch-sensitive surface formed by the touch screen.

The computing device may further comprise a power system for powering the various components. The power system may comprise a power management system, one or more power sources (e.g., battery, alternating current (AC)), a recharging system, a power failure detection circuit, a power converter or inverter, a power status indicator (e.g., a light-emitting diode (LED)) and/or any other components associated with the generation, management and distribution of power in portable devices.

The memory may be configured to store application such as GPS module (or sets of instructions). The GPS module determines the location of the device and provides this information for use during a user's drive.

Modules and applications correspond to a set of instructions for performing one or more functions described above. These modules (i.e., sets of instructions) need not be implemented as separate software programs, procedures or modules, and thus various subsets of these modules may be combined or otherwise re-arranged in various embodiments. Furthermore, memory may store additional modules and data structures not described herein.

While several illustrative embodiments of the invention have been shown and described, numerous variations and alternative embodiments will occur to those skilled in the art. Such variations and alternative embodiments are contemplated, and can be made without departing from the scope of the invention as defined in the appended claims.

As used in this specification and the appended claims, the singular forms “a,” “an,” and “the” include plural referents unless the content clearly dictates otherwise. The term “plurality” includes two or more referents unless the content clearly dictates otherwise. Unless defined otherwise, all technical and scientific terms used herein have the same meaning as commonly understood by one of ordinary skill in the art to which the disclosure pertains.

The foregoing detailed description of exemplary and preferred embodiments is presented for purposes of illustration and disclosure in accordance with the requirements of the law. It is not intended to be exhaustive nor to limit the invention to the precise form(s) described, but only to enable others skilled in the art to understand how the invention may be suited for a particular use or implementation. The possibility of modifications and variations will be apparent to practitioners skilled in the art. No limitation is intended by the description of exemplary embodiments which may have included tolerances, feature dimensions, specific operating conditions, engineering specifications, or the like, and which may vary between implementations or with changes to the state of the art, and no limitation should be implied therefrom. Applicant has made this disclosure with respect to the current state of the art, but also contemplates advancements and that adaptations in the future may take into consideration of those advancements, namely in accordance with the then current state of the art. It is intended that the scope of the invention be defined by the Claims as written and equivalents as applicable. Reference to a claim element in the singular is not intended to mean “one and only one” unless explicitly so stated. Moreover, no element, component, nor method or process step in this disclosure is intended to be dedicated to the public regardless of whether the element, component, or step is explicitly recited in the claims. No claim element herein is to be construed under the provisions of 35 U.S.C. Sec. 112, sixth paragraph, unless the element is expressly recited using the phrase “means for . . . ” and no method or process step herein is to be construed under those provisions unless the step, or steps, are expressly recited using the phrase “step(s) for . . . .”

1: A method of determining a driving route, comprising:
inputting the desired destination into an app or GPS;
inputting the desired driving time into the app or GPS; and
initiating the route calculation in the app or GPS.

2: The method of determining a driving route of claim 1, further comprising:
inputting the desired type of drive into the app or GPS before initiating route calculation.

3: The method of determining a driving route of claim 1, further comprising:
inputting the desired origin point into the app or GPS before initiating route calculation.

3: A device for determining a driving route, comprising:
a user interface; and
computing hardware, wherein the computing hardware is configured to accept the desired driving time and desired destination as inputs for calculating the driving route.

4: the device for determining a driving route of claim 1, wherein the computing hardware is further configured to accept the desired origin point as an input for calculating the driving route.
